(19) United States
(12) Patent Application Publication
(10) Pub. No.: US 2014/0047557 A1
(43) Pub. Date: Feb. 13, 2014

(54) PROVIDING ACCESS OF DIGITAL CONTENTS TO ONLINE DRM USERS

(71) Applicant: Infosys Limited, Bangalore (IN)

(72) Inventors: Ravi Sankar Veerubhotla, Hyderabad (IN); Ashutosh Saxena, Hyderabad (IN); Shikha Gupta, New Delhi (IN); Harigopal K.B. Ponnapalli, Hyderabad (IN)

(73) Assignee: Infosys Limited, Bangalore (IN)

(21) Appl. No.: 13/941,269

(22) Filed: Jul. 12, 2013

(30) Foreign Application Priority Data
Jul. 16, 2012 (IN) 2865/CHE/2012

(51) Int. Cl. G06F 21/10

(52) U.S. Cl. CPC G06F 21/10
USPC 726/28

(57) ABSTRACT

The invention relates to a system and method providing access of one or more heterogeneous digital contents to at least one online Digital Rights Management (DRM) user by a DRM server. This invention involves receiving digital contents from the publishers and those digital contents are encrypted and user rights are granted to access the contents by the publisher. The DRM server stores the decryption information, user rights and user information in a repository. After authenticating the user who is connected with the DRM server through a DRM client, the DRM server sends a license to the DRM user which includes the decryption information and the user rights. The DRM client decrypts the contents based on the license information in the memory of the user's computer device and thus the content and the license are not locally stored.

### FIELD

The present invention relates generally to provide access for protected digital contents to Digital Rights Management (DRM) users, and in particular, to a system and method for providing access of digital contents to online DRM users.

### BACKGROUND

Digital Rights Management (DRM) is a term for access control technologies that can be used by copyright holders, publishers and hardware manufacturers to limit the usage of digital contents and devices. The digital contents can be in the form of documents, e-books, audio, video and game, software libraries. DRM controls the access of sensitive contents by including information about the user rights (i.e. permissions, constraints and obligations) associated with that content. The digital rights management also involves cryptographic techniques and access control mechanisms for preventing unauthorized access; and control usage of contents. Such limitations include the number of copies that may be printed, whether the file may be copied, duration of the file may be accessed and whether the content may be edited.

Presently, a range of DRM solutions are available in the market. These DRM solutions combine code obfuscation techniques along with software license solutions to protect their products from reverse engineering, tampering and exploitation. Software guards, encoding techniques and watermarking techniques are also used to hide and track source code. In case of evaluation software, a serial number is provided by the software vendor to activate the product.

There are few limitations for the present DRM solutions. Existing DRM solutions do not provide a uniform framework for the protection of multiple content types such as digital objects, libraries, executables etc. Their relevance and usage is restricted to a particular type of content or a selective range of content types. No DRM solutions at present offer any default protection to software applications. The code obfuscation techniques used by the existing solutions can resist reverse engineering techniques to some extent but cannot offer a foolproof protection. Encoding techniques can also offer only limited protection as the file formats has to be proprietary and create problems during integration with open systems. Watermarking solutions can act as deterrent only but cannot actively prevent misuse of software. Password protection techniques are common but often come up with an over load such as sharing of passwords. In case of evaluation software, the protection can be easily overcome by the evaluators by clearing registry entities or resetting the system clock. More over the same activation key is used on different machines to get access to multiple installations. The software providers have no control on the license already issued by them. While an evaluator violates the licensing terms and the software providers cannot revoke the license.

In view of the foregoing discussion, there is a need for a DRM solution that can provide uniform framework to protect digital contents and software libraries and can protect multiple digital formats and support a variety of clients on different platforms.

### SUMMARY

The present invention overcomes all the above mentioned limitations and it provides a uniform framework to protect digital contents and software libraries, it protects multiple digital formats and support for variety of clients on different platforms. It improves support for online DRM model since neither an unprotected digital content nor a DRM license associated with it persisted on the client end. This DRM protection can also be applied for any new type of data by utilizing the DRM APIs which can render that type of data.

According to the present embodiment, a method for providing access of one or more heterogeneous digital contents to at least one online Digital Rights Management (DRM) user by a DRM server is disclosed. The method includes receiving the one or more heterogeneous digital contents from a publisher, wherein the publisher encrypts the one or more heterogeneous digital contents before or after uploading into the DRM server and grants one or more rights to the at least one DRM user with respect to the one or more heterogeneous digital contents after uploading into the DRM server. Further, information related to decryption of the one or more encrypted heterogeneous digital contents, the one or more granted rights and information related to the at least one user are stored in the repository of the DRM server. After that, when the at least one DRM user wants to render the one or more heterogeneous digital contents, the DRM server authenticates the at least one DRM user based on the information related to the at least one user previously stored in the repository. If the at least one DRM user is authenticated then, the DRM server generates a DRM license, wherein the DRM license includes the information for decrypting the one or more encrypted heterogeneous digital contents and the one or more granted rights for the at least one authenticated DRM user. After generating the DRM license, the DRM server sends the license to the at least one authenticated DRM user to render the digital contents.

In an additional embodiment, a system for providing access of one or more heterogeneous digital contents to at least one online Digital Rights Management (DRM) user by a DRM server is disclosed. The system includes a heterogeneous digital content receiving module, a user rights management module, a repository, an authentication module, a license management module. The heterogeneous digital content receiving module is configured for receiving the one or more heterogeneous digital contents from a publisher, wherein the publisher encrypts the one or more heterogeneous digital contents before or after uploading into the DRM server. In accordance with an embodiment of the present disclosure, the publisher uses an encryption module to encrypt the heterogeneous digital contents. The user rights management module configured for granting and revoking one or more rights with respect to the one or more heterogeneous digital contents for the at least one DRM user. The repository is configured for storing information related to the at least one user, information related to decryption of the one or more encrypted heterogeneous digital contents and the one or more granted rights. The authentication module is configured for authenticating the at least one DRM user who wants to render the one or more heterogeneous digital contents based on information related to the at least one user previously stored in the repository and the license management module is configured for generating and sending a DRM license to the at least one authenticated DRM user to consume the one or more heterogeneous digital contents.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which:

FIG. 1 illustrates an environment in which various embodiments of the invention presented herein may be practiced;

FIG. 2 a block diagram illustrating a system for providing access of one or more heterogeneous digital contents to at least one online Digital Rights Management (DRM) user by a DRM server, in accordance with an embodiment of the present invention.

FIG. 3 is a flowchart, illustrating a method for providing access of one or more heterogeneous digital contents to at least one online Digital Rights Management (DRM) user by a DRM server, in accordance with an embodiment of the present invention.

FIG. 4 is a flowchart, illustrating a method for providing access of one or more software libraries to at least one online Digital Rights Management (DRM) user by a DRM server, in accordance with an embodiment of the present invention.

FIG. 5 is a block diagram of the DRM server displaying API for the DRM client integration.

FIG. 6 is a workflow illustrating the integration of the DRM server with the DRM client.

FIG. 7 is a computer architecture diagram illustrating a computing system capable of implementing the embodiments presented herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a system and method for providing access of one or more heterogeneous digital contents to at least one online Digital Rights Management (DRM) user by a DRM server. This involves uploading the digital contents by a publisher in the DRM server. The digital contents are then encrypted by the publisher. Alternatively, the publisher can encrypt the digital contents before uploading into the DRM server. After encrypting the digital contents the publisher grants one or more rights to the users to access the digital contents. The DRM server stores the decryption information of the encrypted digital contents and the user rights granted by the publishers. The DRM server also stores the user information in its repository. When the user login to the DRM server and request access for the digital contents through a DRM client then the DRM server authenticates the user and only after authentication the DRM server generates a DRM license which contains the decryption information and user rights information. Finally, the DRM server sends the DRM license to the authenticated user for rendering the digital contents.

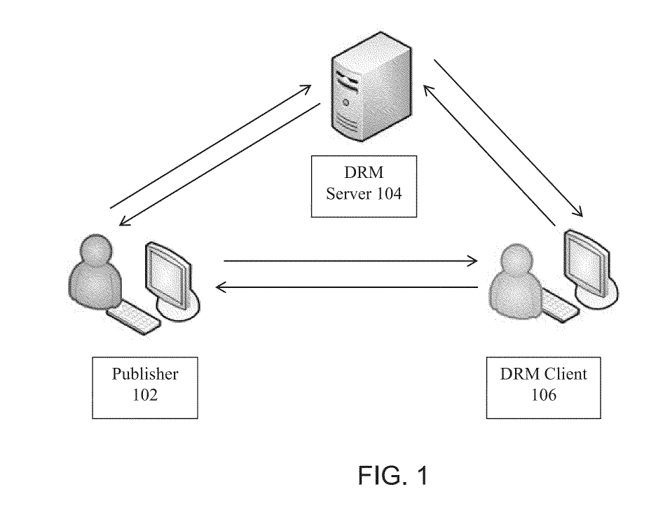

FIG. 1 illustrates an environment in which various embodiments of the invention presented herein may be practiced. This involves publisher 102, DRM server 104 and a DRM client 106. To solve the problem of unauthorized copying and limiting the access to the rightful individual, the digital contents is uploaded in the DRM server 104 and encrypted by the publisher 102. In an alternate embodiment, the publisher 102 can encrypt the content before uploading into the DRM server 104. The publisher 102 grants user rights to access the digital contents. The DRM server 104 is responsible for managing the secret key for decrypting the digital contents and also the user rights. The DRM client 106 enforces the granted user rights. As will be understood in detail below, the DRM server generates and sends the DRM license to users upon authentication of the user for rendering the digital contents.

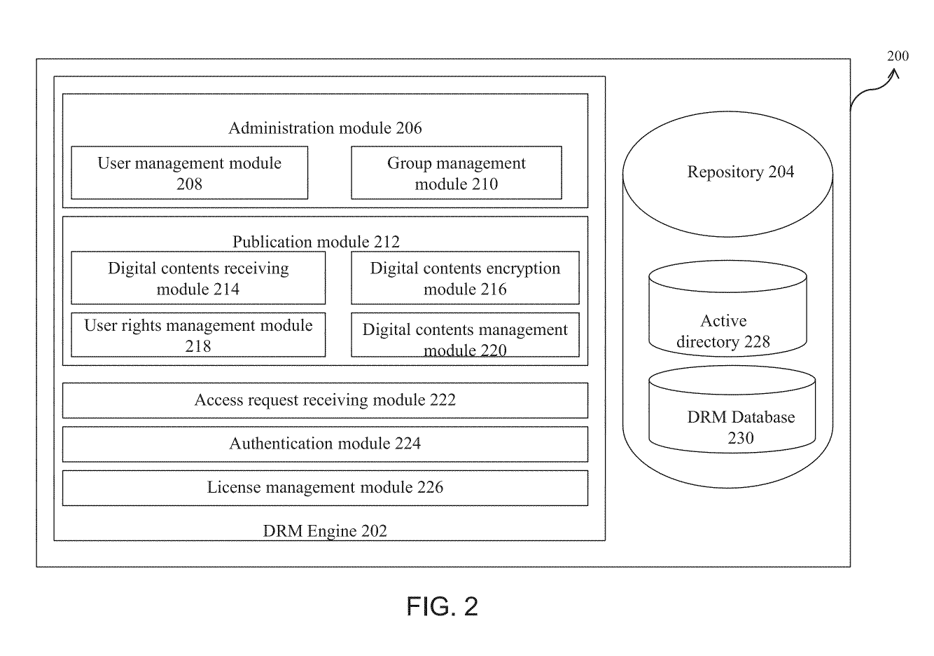

FIG. 2 a block diagram illustrating a system for providing access of one or more heterogeneous digital contents to at least one online Digital Rights Management (DRM) user by a DRM server, in accordance with an embodiment of the present invention. Broadly, the DRM server has two main components; these are a DRM engine 202 and a repository 204. The DRM engine 202 located in the server 200 is responsible for managing the digital content as well as the users. The DRM engine 202 includes an administration module 206, a publication module 212, a access request receiving module 222, an authentication module 224 and a license management module 226. The administration module 206 further includes user management module 208 and group management module 210. The administrator can manage an individual user through user management module 208 and also can manage a group of individuals through group management module 210. Each member of a group gets the same rights. DRM administrator can add, delete and edit the users in the DRM groups. Users can also be moved from one group to the other. The publication module 212 includes digital contents receiving module 214, digital contents encryption module 216, user rights management module 218 and digital content management module 220. The DRM server 200 receives the digital contents from the publishers through the digital contents receiving module 214. The digital contents may include but are not limited to texts, images, audio, video, mobile applications, games, software libraries and combination thereof. The publishers have the right to upload their contents and assign rights to others. The publisher may be the owner of the digital contents and/or the distributors of the digital contents or any other person who is authorized to upload the contents in the DRM server 200. After uploading the digital contents the publisher encrypts the digital contents with a secret key by using the digital contents encryption module 216. In an alternative embodiment, the publisher can encrypt the digital contents before uploading into the DRM server. Apart from the encryption algorithms, the digital contents can be protected by using encoding techniques and/or watermarking. After encrypting the contents the publisher grants one or more rights to the end users for accessing the digital contents by using the user rights management module 218. One publisher cannot grant rights on the contents published by another publisher. The users can request the rights only after authentication by the DRM server. The user rights may include but are not limited to printing, viewing, executing, playing, copying and editing. In addition to these rights, publishers may set few constraints such as time limit or number of views. The permission and constraints can be enforced at granular level, for selected users on selected contents. Revocation of rights is also possible. The content management module 220 is responsible for packaging all the protection mechanisms and distributing the packaged protected digital contents to the DRM users. The DRM users who want to render the digital contents use a DRM client to communicate with the DRM server. The request to access the digital contents from the DRM client is received through the access request receiving module 222. After receiving the access request the DRM server checks whether the input credentials by the DRM user is correct or not. If the user credentials matches with the user information stored in the repository 204 then the DRM server authenticates the DRM user through the authentication module 224. The license management module 226 is responsible for generating a DRM license for accessing the digital contents by the authenticated DRM user and sending the license to the authenticated DRM users. The DRM license includes the decryption information, e.g. the decryption key to decrypt the encrypted digital contents, encryption algorithm, DRM server location and also the user rights information. The repository 204 includes an active directory 228 which stores all the DRM users' information to authenticate the DRM users and a DRM database 230 to store decryption information and user rights information.

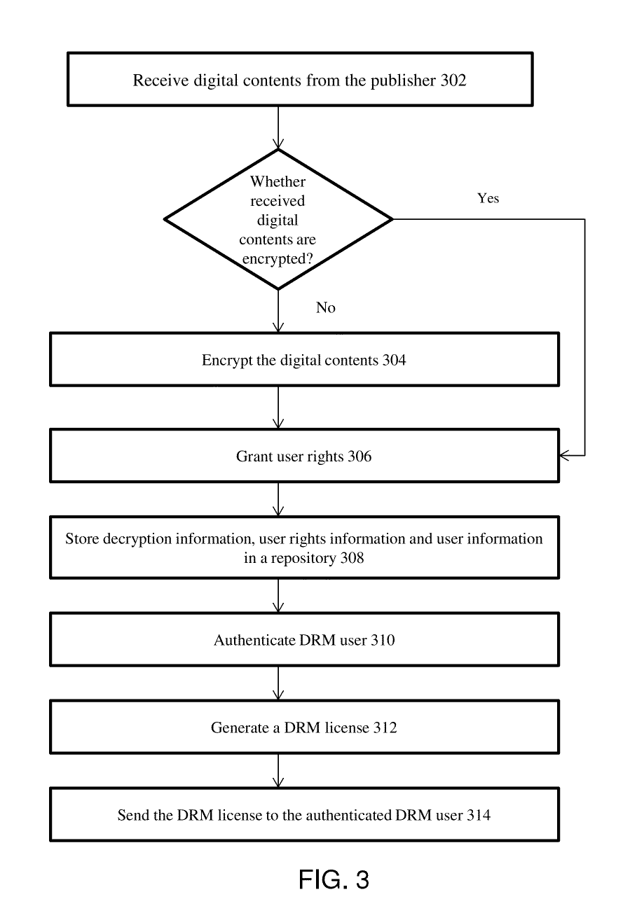

FIG. 3 is a flowchart, illustrating a method for providing access of one or more heterogeneous digital contents to at least one online Digital Rights Management (DRM) user by a DRM server, in accordance with an embodiment of the present invention. In various embodiments of the present invention, the examples of digital contents may include but are not limited to texts, images, audio, video, mobile applications, games, software libraries and combination thereof. The DRM server receives the digital contents from the publishers, as in step 302. The publisher may be the owner of the digital contents and/or the distributor of the digital contents or any other person who are authorized to upload the digital contents into the DRM server and grant user rights. The received digital contents may be encrypted by the publisher before uploading into the DRM server or alternatively, the publisher can encrypt the digital contents after uploading into the DRM server, as in step 304. Apart from the encryption algorithms the digital contents may be secured through encoding techniques and/or watermarking. After the digital contents are encrypted with the help of a secret key by the publisher, the publisher then grants one or more rights for the DRM users who want to access the digital contents, as in step 306. One publisher cannot grant rights on the contents published by another publisher. The user rights may include but are not limited to printing, viewing, executing, playing, copying and editing. In addition to these rights, publishers may set few constraints such as time limit or number of views. The permission and constraints can be enforced at granular level, for selected users on selected contents. Revocation of rights is also possible. By changing the rights information on the server the publisher can grant new rights or extend existing privileges to the user. This online model provides the greatest flexibility when assigning rights to any combination of users and content. The repository of the DRM server stores the decryption information, e.g. the secret key to decrypt the encrypted digital contents, encryption algorithm, DRM server location, the user rights information and also the user information to authenticate the users, as in step 308. The DRM user uses a DRM client to communicate with the DRM server. If the DRM user wants to access the digital contents then the DRM client has to be connected with the DRM server. Once connected the DRM user first login to the DRM server by providing the required credentials and these information is compared with the user information stored previously in the repository and if the input credential by the DRM user matches with the stored user information in the DRM server then the DRM server authenticates the DRM users, as in step 310. If the authentication fails the process stops at here. If authentication succeeds then the DRM server generates a DRM license which includes information related to the decryption (e.g. the secret key) of the encrypted content and also the granted user rights, as in step 312. After that, the DRM license is sent to the DRM users through a secure session (https), as in step 314. The DRM client decrypts the digital contents in the memory by using the decryption key and enforces the user rights specified in the DRM license. In this case, neither the decrypted content nor the DRM license is locally stored in the computer device of the DRM users.

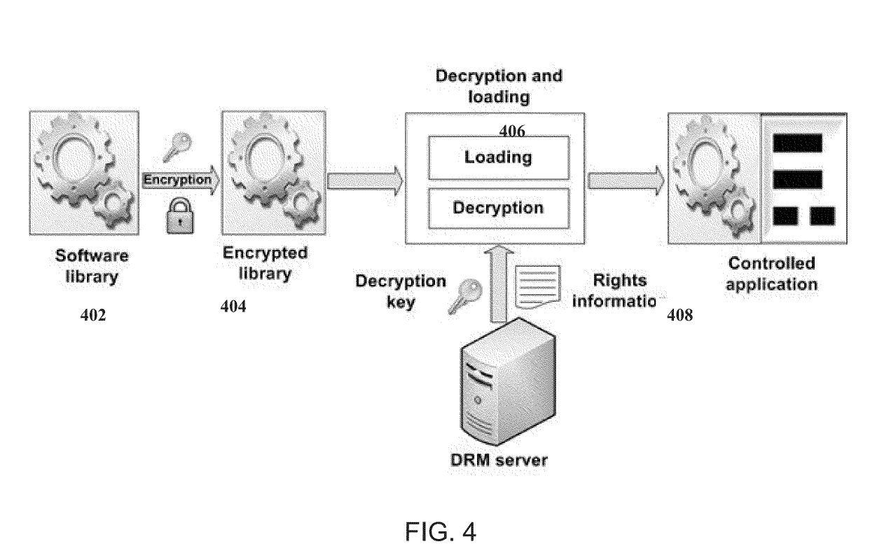

FIG. 4 is a flowchart, illustrating a method for providing access of one or more software libraries to at least one online Digital Rights Management (DRM) user by a DRM server, in accordance with an embodiment of the present invention. In this, the core functions of the software are implemented by the publisher and a library file is created for it which is called as software library, as mentioned in 402. Then, the library file is encrypted by the publisher by using a strong encryption algorithm to protect it from illegal exploitation, as mentioned in 404. Then, the encrypted library is uploaded into the DRM server. Alternatively, the encryption step can be performed after uploading the library into the DRM server. Thereafter, the publisher grants execution rights on this library file to legitimate DRM users. The DRM user authenticates to the DRM server and gets a DRM license required to run the software. The DRM client integrated with the software reads the encrypted library and decrypts it in memory of the DRM user's computing device using decryption key from the DRM license and after decryption the DRM client loads the software library into the memory, as mentioned in 406. Then the library functions will be available for use by refection API calls and the execution is controlled by the DRM server, as mentioned in 408.

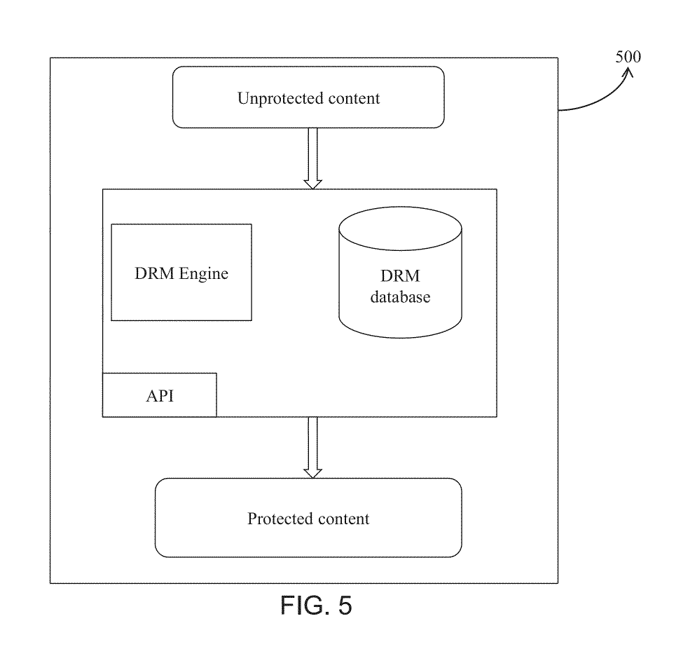

FIG. 5 is a block diagram of the DRM server displaying API for the DRM client integration 500. The present DRM protection can be applied for any existing or new type of data by utilizing DRM APIs. So, sometime later if a new type of data comes into existence the same DRM protection can be applied for those by creating a DRM client using the DRM APIs which can render the new type of data. The new DRM client can be integrated with the present DRM server using an API.

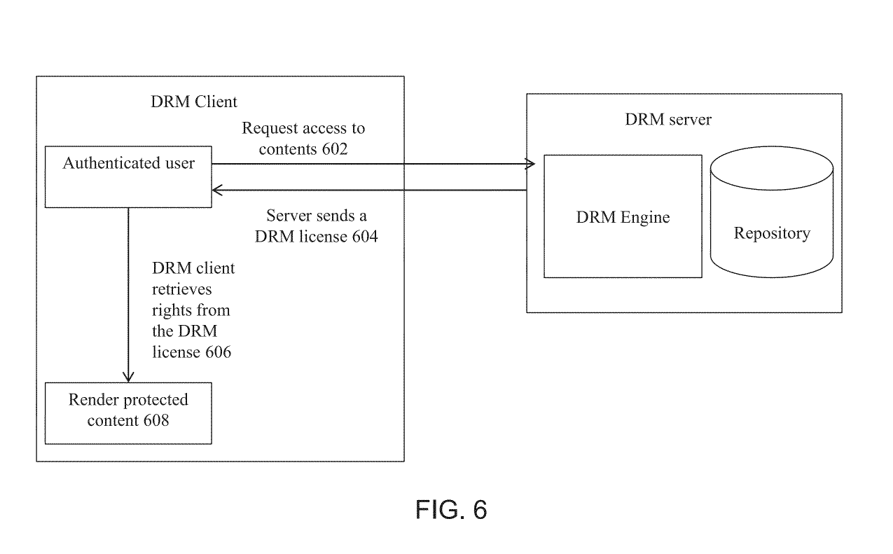

FIG. 6 is a workflow illustrating the integration of the DRM server with the DRM client. An authenticated DRM user sends a secure https request to the DRM server through a DRM client to access the encrypted digital contents uploaded by the publisher, as in step 602. The DRM server sends the DRM license to the authenticated user which includes the user rights information set by the publisher and the decryption information to decrypt the encrypted content, as in step 604. Then, the DRM client decrypts the encrypted digital contents in the memory and retrieves the user rights information from the DRM license, as in step 606. Based on that, the DRM client render the protected digital content by using a customized software application, as mentioned in step 608. The authorized DRM user can render the content at any machine by using the DRM client.

### Computing Environment

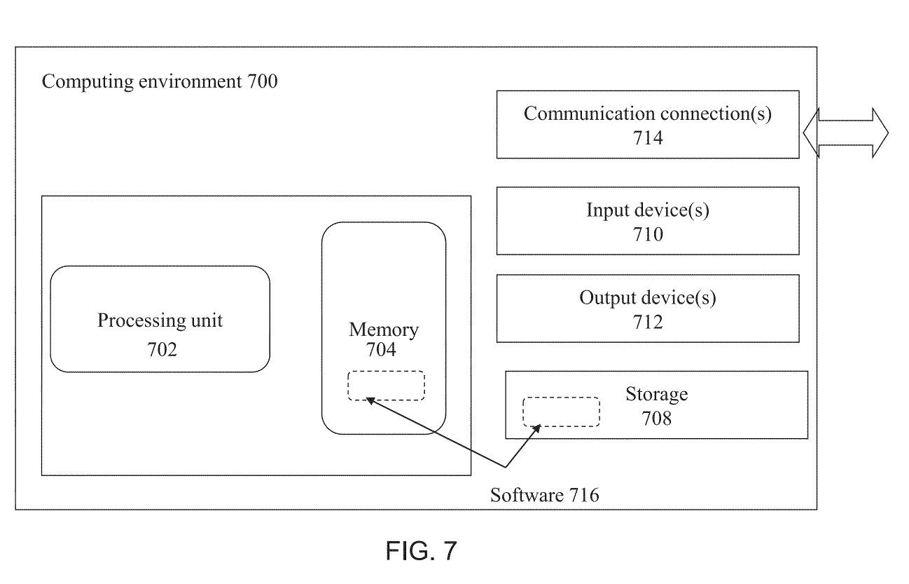

FIG. 7 is a computer architecture diagram illustrating a computing system capable of implementing the embodiments presented herein. The computing environment 700 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 7, the computing environment 700 includes at least one central processing unit 702 and memory 704. The central processing unit 702 executes computer-executable instructions. In a multi-processing system, multiple processing units execute computer-executable instructions to increase processing power and as such, multiple processors can be running simultaneously. The memory 704 may be volatile memory (e.g., registers, cache, RAM), non-volatile memory (e.g., ROM, EEPROM, flash memory, etc.), or some combination of the two. The memory 704 stores software 716 that can implement the technologies described herein. A computing environment may have additional features. For example, the computing environment 700 includes storage 708, one or more input devices 710, one or more output devices 712, and one or more communication connections 714. An interconnection mechanism (not shown) such as a bus, a controller, or a network, interconnects the components of the computing environment 700. Typically, operating system software (not shown) provides an operating environment for other software executing in the computing environment 700, and coordinates activities of the components of the computing environment 700.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A method, executed by one or more computing devices, for providing access of one or more heterogeneous digital contents to at least one online Digital Rights Management (DRM) user by a DRM server, the method comprising:
receiving, by at least one of the computing devices, the one or more heterogeneous digital contents from a publisher, wherein the publisher encrypts the one or more heterogeneous digital contents before or after uploading into the DRM server and grants one or more rights to the at least one DRM user with respect to the one or more heterogeneous digital contents after uploading into the DRM server;
storing information related to decryption of the one or more encrypted heterogeneous digital contents, the one or more granted rights and information related to the at least one user in a repository;
authenticating, by at least one of the computing devices, the at least one DRM user who wants to render the one or more heterogeneous digital contents based on the information related to the at least one user previously stored in the repository;
generating a DRM license, wherein the DRM license includes the information for decrypting the one or more encrypted heterogeneous digital contents and the one or more granted rights for the at least one authenticated DRM user; and
sending, by at least one of the computing devices, a DRM license to the at least one authenticated DRM user.

2. The method as claimed in claim 1 further comprising:
rendering through a customized software application the one or more heterogeneous digital contents upon decryption based on the one or more granted rights.

3. The method as claimed in claim 2, wherein the step of rendering comprises:
receiving the one or more heterogeneous digital contents by the at least one DRM user; and
decrypting the one or more heterogeneous digital contents in a memory of a computing device of the at least one DRM user.

4. The method as claimed in claim 1, wherein the at least one DRM user uses a DRM client to communicate and authenticate with the DRM server.

5. The method as claimed in claim 1, wherein the DRM server integrates one or more third party DRM clients through an Application Programming Interface (API) call.

6. The method as claimed in claim 1, wherein the one or more heterogeneous digital contents comprises one or more texts, images, audio, video, mobile applications, games, software libraries and combination thereof.

7. The method as claimed in claim 6, wherein the one or more encrypted software libraries are loaded at a computing device of the at least one DRM user by using one or more custom class loaders and a library API with reflection for a software application.

8. The method as claimed in claim 1, wherein the DRM server controls an execution of the one or more software libraries.

9. The method as claimed in claim 1, wherein the one or more granted rights include at least one of one or more constraints and permission for at least one of printing, viewing, executing, playing, copying and editing.

10. The method as claimed in claim 9, wherein the one or more constraints include at least one of time limit and number of views.

11. The method as claimed in claim 1, wherein the publisher can revoke any of the one or more granted rights.

12. The method as claimed in claim 1, wherein the one or more decrypted heterogeneous digital contents and the DRM license are stored in the memory of the computing device but not locally stored in the computing device of the at least one DRM user.

13. The method as claimed in claim 1, wherein the DRM license is sent to the at least one authenticated DRM user through a secure http response.

14. A system for providing access of one or more heterogeneous digital contents to at least one online Digital Rights Management (DRM) user by a DRM server comprising:
a processor in operable communication with a processor readable storage medium, the processor readable storage medium containing one or more programming instructions whereby the processor is configured to implement:
a heterogeneous digital content receiving module configured to receive the one or more heterogeneous digital contents from a publisher, wherein the publisher encrypts the one or more heterogeneous digital contents before or after uploading into the DRM server;
a user rights management module configured to grant and revoke one or more rights with respect to the one or more heterogeneous digital contents for the at least one DRM user;
a repository at the DRM server configured to store information related to the at least one user, information related to decryption of the one or more encrypted heterogeneous digital contents and the one or more granted rights;
an authentication module configured to authenticate the at least one DRM user who wants to render the one or more heterogeneous digital contents based on information related to the at least one user previously stored in the repository; and
a license management module configured to generate and send a DRM license to the at least one authenticated DRM user to consume the one or more heterogeneous digital contents.

15. The system as claimed in claim 14 further comprising:
a content management module configured to package one or more protection mechanisms and distribute the one or more protected heterogeneous digital contents to the at least one DRM user.

16. The system as claimed in claim 14 further comprising:
an administrator configured to manage one or more users and/or one or more groups.

17. The system as claimed in claim 14, wherein, the publisher uses an encryption module of the DRM server in the event of encrypting the one or more heterogeneous digital contents.

18. The system as claimed in claim 14, wherein the at least one DRM user uses a DRM client to communicate and authenticate with the DRM server.

19. The system as claimed in claim 14, wherein the DRM server integrates one or more third party DRM clients through an Application Programming Interface (API) call.

20. The system as claimed in claim 14, wherein the one or more heterogeneous digital contents comprises one or more texts, images, audio, video, mobile applications, games and software libraries and combination thereof.

21. The system as claimed in claim 20, wherein the one or more encrypted software libraries are loaded at a computing device of the at least one DRM user by using one or more custom class loaders and a library API with reflection for a software application.

22. The system as claimed in claim 14, wherein the one or more granted rights include at least one of one or more constraints and permission for at least one of printing, viewing, executing, playing, copying and editing.

23. The system as claimed in claim 22, wherein the one or more constraints include at least one of time limit and number of views.

24. The system as claimed in claim 14, wherein the DRM license includes the information for decrypting the one or more heterogeneous digital contents by the at least one DRM user and the one or more granted rights for the at least one DRM user.

25. The system as claimed in claim 14, wherein the one or more heterogeneous digital contents are rendered through a customized software application.
